(19) United States
(12) Patent Application Publication
(10) Pub. No.: US 2023/0249323 A1
(43) Pub. Date: Aug. 10, 2023

(54) SOCKET WRENCH

(71) Applicant: TIEN-I INDUSTRIAL CO., LTD., Taichung City (TW)

(72) Inventor: Larry LEE, Taichung City (TW)

(21) Appl. No.: 18/304,203

(22) Filed: Apr. 20, 2023

Related U.S. Application Data
(63) Continuation-in-part of application No. 17/386,902, filed on Jul. 28, 2021.

(51) Int. Cl. B25B 23/00; B25B 13/06

(52) U.S. Cl. CPC B25B 23/0028; B25B 13/06

(57) ABSTRACT

A socket wrench is provided, including: a sleeving portion, including a sleeving hole disposed therethrough along a first direction; a connecting arm, extending from the sleeving portion in a direction lateral to the first direction; an operation rod; and a pin member, pinning the connecting arm and the operation rod in a direction non-perpendicular to the first direction so that the operation rod is rotatable about the pin member relative to the sleeving portion.

### BACKGROUND OF THE INVENTION

### Field of the Invention

The present invention is a CIP of application Ser. No. 17/386,902, filed Jul. 28, 2021, the entire contents of which are hereby incorporated by reference.

### Description of the Prior Art

Fasteners are used in many kinds of products to assemble components. Fasteners, such as screws, nuts, bolts or the like, are generally fastened or loosened by turning, and this is usually carried out by using socket wrench which is sleeved on the fastener and extended with an extension driving rod.

The conventional socket wrenches are, for example, disclosed in TW M243305, TW M572814 and TW M576520.

However, the conventional socket wrench mentioned above needs to be operated in a specific direction in actual operation. Once the conventional socket wrench operates in an environment with too much debris or in a small space, its mobility and adaptability are insufficient, which causes troubles in disassembly and assembly operations.

U.S. Pat. No. 7,171,876 discloses that the sleeving portion and the connecting arm are separate members and not integrally formed of one piece, and the sleeving portion and the connecting arm are rotatable about different axes, respectively, and discloses that the pin member is provided with none recesses on opposing ends, respectively. The pin member cannot be screwed to or unscrewed from the two ear portions by a driving tool from the end without an assembling portion.

U.S. Pat. No. 3,424,212 discloses that the second assembling portion extends through the pin member, so the pin member is entirely hollow. As such, the pin member has weak structural strength so that it is not sufficiently strong for serving as the rotation shaft of the socket wrench.

U.S. Pat. No. 6,095,736 discloses that in the axial direction of the pin member, the sum of a depth of the first assembling portion and a depth of the second assembling portion is larger than one half a length of the pin member. When the pin member is applied to the two ear portions, the first and second assembling portions extend within the through holes for respective distances larger than one half a thickness of any of the two ear portions. As such, the pin member has weak structural strength so that it is not sufficiently strong for serving as the rotation shaft of the socket wrench.

U.S. Ser. No. 11/511,401 discloses that a sleeving hole of a sleeving portion is open in a direction perpendicular to a direction in which through holes of two ear portions connected to the sleeving portion are open.

The present invention is, therefore, arisen to obviate or at least mitigate the above-mentioned disadvantages.

### SUMMARY OF THE INVENTION

The main object of the present invention is to provide a socket wrench which is swingable, can evenly transmit force, and is uneasy to be damaged and broken.

To achieve the above and other objects, a socket wrench is provided, including: a sleeving portion, including a sleeving hole disposed therethrough along a first direction; a connecting arm, extending from the sleeving portion in a direction lateral to the first direction; an operation rod; and a pin member, pinning the connecting arm and the operation rod in a direction non-perpendicular to the first direction so that the operation rod is rotatable about the pin member relative to the sleeving portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a cross-sectional view of a preferable embodiment of the present invention;

FIG. 4 is a drawing showing operation of a preferable embodiment of the present invention; and

FIGS. 5 and 6 are drawings showing operation of removing a pin member which is broken according to a preferable embodiment of the present invention.

### DETAILED DESCRIPTION OF THE PREFERRED EMBODIMENTS

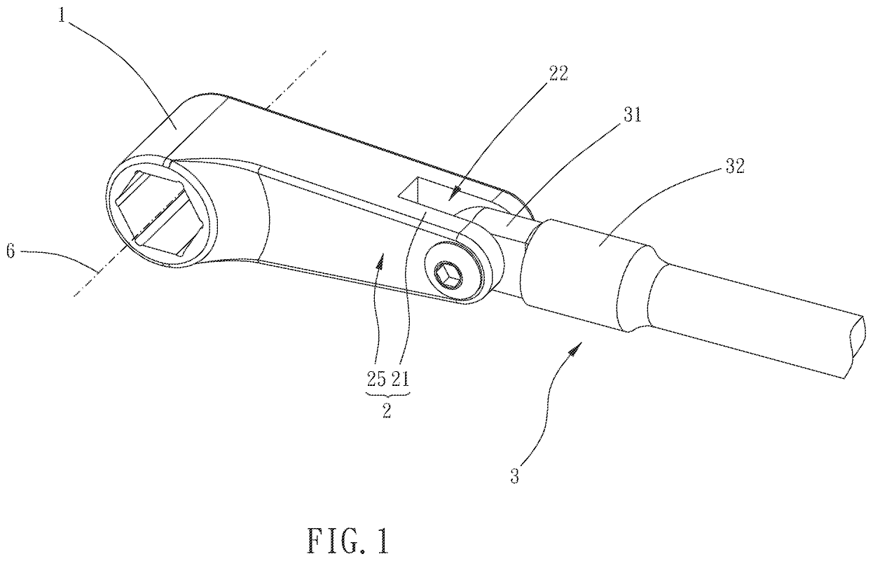

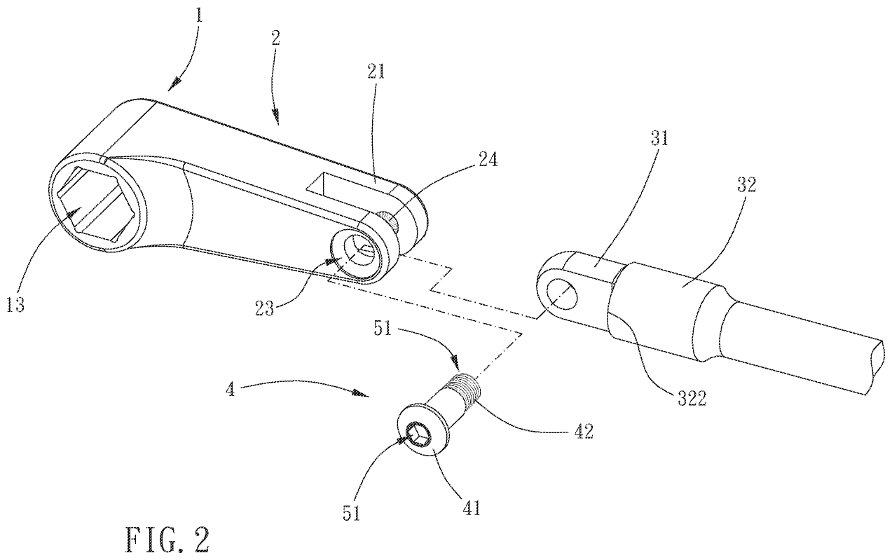

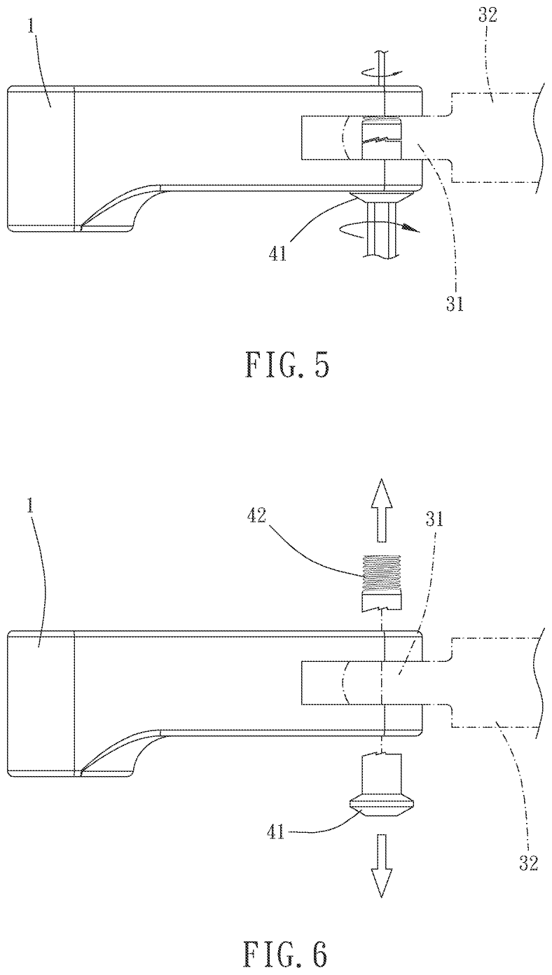

Please refer to FIGS. 1 to 6 for a preferable embodiment of the present invention. A socket wrench of the present invention includes a sleeving portion 1, a connecting arm 2, an operation rod 3 and a pin member 4.

The sleeving portion 1 includes a sleeving hole 13 disposed therethrough along a first direction 6, and the sleeving hole 13 is hexagonal and configured for connection with a screw, nut, bolt or the like. The connecting arm 2 extends integrally from the sleeving portion 1 in a direction lateral to the first direction 6, which provides good structural strength. The pin member 4 pins the connecting arm 2 and the operation rod 3 in a direction non-perpendicular to the first direction 6 so that the operation rod 3 is rotatable about the pin member 4 relative to the sleeving portion 1.

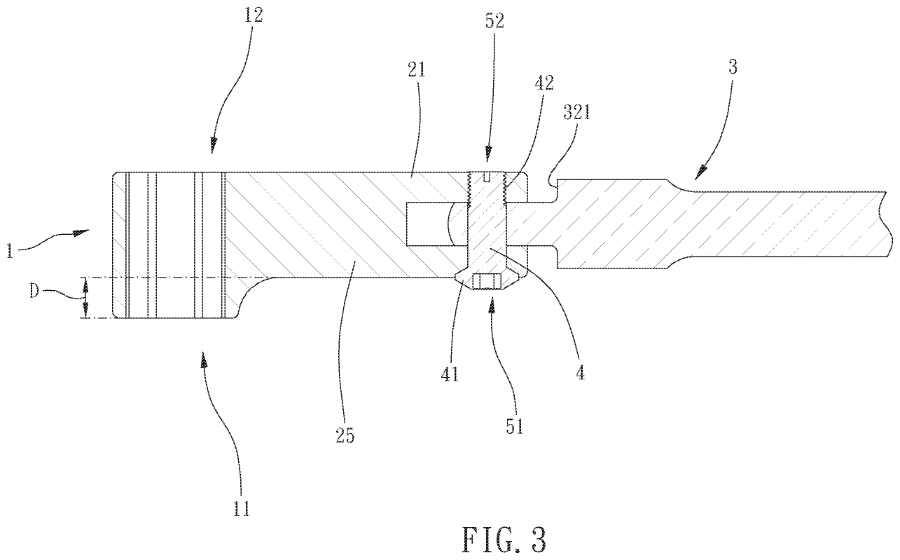

In this embodiment, as shown in FIG. 3, the pin member 4 pins the connecting arm 2 and the operation rod 3 in a direction parallel to the first direction 6, wherein the pin member 4 extending in a direction the same as a direction toward which the sleeving hole 13 is open, and thus when the sleeving portion 1 is disposed around the fastener and rotates, a force from the operation rod 3 is applied to the pin member 4 in a radial direction of the pin member 4 so that there is sufficient area on the pin member 4 to bear the force from the operation rod 3, the force can be evenly distributed and transmitted to the connecting arm 2. As a result, the pin member 4 is uneasy to be damaged and broken.

Specifically, the connecting arm 2 includes two ear portions 21, the two ear portions 21 are arranged in interval and define an insertion space 22 therebetween, the operation rod 3 extends partially within the insertion space 22, each of the two ear portions 21 includes a through hole 23 and a threaded hole 24, the pin member 4 is disposed through the through hole 23 and the operation rod 3 and is screwed within the threaded hole 24, and thus the pin member 4 can transmit the force from the operation rod 3 evenly to the two ear portions 21.

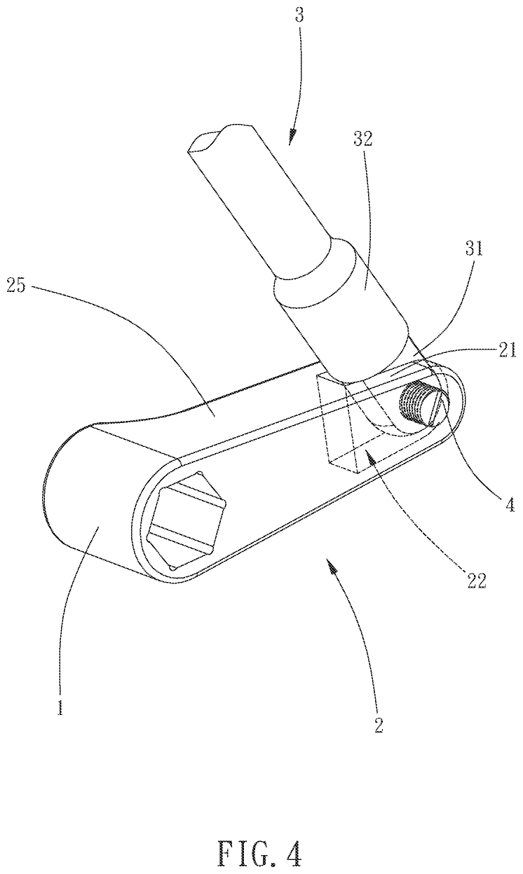

Specifically, the connecting arm 2 further includes a main body 25, the main body 25 is connected between the two ear portions 21 and the sleeving portion 1, and in the axial direction of the pin member 4, the sleeving portion 1 is protrusive beyond the main body 25 for a distance D larger than one quarter a thickness of the main body 25. The operation rod 3 further includes a head portion 31 and a body portion 32 connected with each other, the head portion 31 extends within the insertion space 22, and the body portion 32 is located outside the insertion space 22 and has a diametric dimension larger than a distance between the two ear portions 21. Specifically, the body portion 32 has an end surface 321 which has a circular periphery 322, and the head portion 31 is connected to the end surface 321 and located within the circular periphery 322. When the body portion 32 is abutted against the two ear portions 21, the circular periphery 322 of the end surface 321 of the body portion 32 is partially located within the insertion space 22. As shown in FIG. 4, the head portion 31 is plate-shaped, the body portion 32 is cylindrical, and when the operation rod 3 is rotatable to abut the sleeving portion 1 so that the body portion 32 drives at least one of the main body 25 and the two ear portions 21, which lowers the level of force exerted on the pin member 4 so that the pin member 4 is uneasy to be damaged and broken.

The pin member 4 includes a driving portion 41 and a threaded portion 42 corresponding to each other, the through hole 23 is located between the driving portion 41 and the threaded hole 24, the threaded portion 42 is disposed through the through hole 23 and is screwed within the threaded hole 24, and the driving portion 41 is partially engaged within the through hole 23. At least one of an end face of the driving portion 41 and an end face of the threaded portion 42 includes an assembling portion configured for driving the pin member 4 to rotate.

The driving portion 41 includes a first assembling portion 51, and the threaded portion 42 includes a second assembling portion 52. In a normal circumstance, the pin member 4 (not damaged or broken) can be screwed to or unscrewed from the two ear portions 21 by a driving tool engaged with the first assembling portion 51 or the second assembling portion 52 and rotating the pin member 4; when the pin member 4 is damaged or broken, the broken parts of the pin member 4 can be removed from the two ear portions 21, respectively, by a driving tool engaged with the first assembling portion 51 or the second assembling portion 52 and rotating the pin member 4.

Specifically, a diametric dimension of the driving portion 41 is larger than a diametric dimension of the threaded portion 42, and the first assembling portion 51, preferably, is of a structural configuration different from a structural configuration of the second assembling portion 52. Specifically, the first assembling portion 51 and the second assembling portion 52 are recesses, and the first assembling portion 51 has a cross-sectional area larger than a cross-sectional area of the second assembling portion 52, for sufficient connection portions of the threaded portion 42. In this embodiment, the first assembling portion 51 is a polygonal recess and the second assembling portion 52 is a linear recess, which is compatible with most common driving tools such as flathead screwdrivers or hex wrenches.

A first side portion 11 of the sleeving portion 1 and the driving portion 41 are located at the same side of the operation rod 3. Preferably, in the first direction 6, the first side portion 11 is protrusive beyond the connecting arm 2 and relatively higher than the driving portion 41, which is advantageous for operation and prevents collision of the driving portion 41. The first side portion 11 increases the entire length of the sleeving portion 1 in the first direction 6, which can be used for longer fasteners.

The sleeving portion 1 further includes a second side portion 12, the second side portion 12 is located at a side opposite to the first side portion 11, the second side portion 12 and the threaded portion 42 are located at the same side of the operation rod 3, the second side portion 12 and the connecting arm 2 are aligned with each other, and the end face of the threaded portion 42 is non-protrusive beyond the connecting arm 2 for avoiding collision.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A socket wrench, including:
a sleeving portion, including a sleeving hole disposed therethrough along a first direction;
a connecting arm, extending from the sleeving portion in a direction lateral to the first direction;
an operation rod; and
a pin member, pinning the connecting arm and the operation rod in a direction non-perpendicular to the first direction so that the operation rod is rotatable about the pin member relative to the sleeving portion;
wherein the sleeving portion and the connecting arm are integrally formed of one piece;
wherein the connecting arm includes two ear portions, the two ear portions are arranged in interval and define an insertion space therebetween, the operation rod extends partially within the insertion space, the two ear portions include a through hole and a threaded hole, respectively, the pin member is disposed through the through hole and the operation rod and is screwed within the threaded hole, the pin member includes a driving portion and a threaded portion corresponding to each other, the through hole is located between the driving portion and the threaded hole, the threaded portion is disposed through the through hole and is screwed within the threaded hole, the driving portion includes a first assembling portion which is a recess, and the threaded portion includes a second assembling portion which is a recess;
wherein in an axial direction of the pin member, the first assembling portion extends within the through hole for a distance less than one half a thickness of one of the two ear portions, and the second assembling portion extends within the threaded hole for a distance less than one half a thickness of the other of the two ear portions;
wherein in the axial direction of the pin member, the sum of a depth of the first assembling portion and a depth of the second assembling portion is less than one half a length of the pin member;
wherein the sleeving portion and the connecting arm are integrally formed of one piece;
wherein the through hole and the threaded hole are disposed through the two ear portions in a direction parallel to the axial direction of the pin member, respectively;
wherein the sleeving hole, the through hole and the threaded hole are open in a direction parallel to the axial direction of the pin member.

2. The socket wrench of claim 1, wherein the pin member pins the connecting arm and the operation rod in a direction parallel to the first direction.

3. The socket wrench of claim 1, wherein the first assembling portion is of a structural configuration different from a structural configuration of the second assembling portion.

4. The socket wrench of claim 3, wherein the first assembling portion and the second assembling portion are recesses, and the first assembling portion has a cross-sectional area larger than a cross-sectional area of the second assembling portion.

5. The socket wrench of claim 1, wherein the connecting arm further includes a main body, the main body is connected between the two ear portions and the sleeving portion, the operation rod further includes a head portion and a body portion connected with each other, the head portion extends within the insertion space, the body portion is located outside the insertion space and has a diametric dimension larger than a distance between the two ear portions; when the operation rod is rotatable to be near the sleeving portion so that the body portion drives at least one of the main body and the two ear portions.

6. The socket wrench of claim 1, wherein a first side portion of the sleeving portion and the driving portion are located at the same side of the operation rod, and in the first direction, the first side portion is protrusive beyond the connecting arm and relatively higher than the driving portion.

7. The socket wrench of claim 6, wherein the sleeving portion further includes a second side portion, the second side portion is located at a side opposite to the first side portion, the second side portion and the threaded portion are located at the same side of the operation rod, the second side portion and the connecting arm are aligned with each other, and the end face of the threaded portion is non-protrusive beyond the connecting arm.

8. The socket wrench of claim 4, wherein the pin member pins the connecting arm and the operation rod in a direction parallel to the first direction; the connecting arm further includes a main body, the main body is connected between the two ear portions and the sleeving portion, the operation rod further includes a head portion and a body portion connected with each other, the head portion extends within the insertion space, the body portion is located outside the insertion space and has a diametric dimension larger than a distance between the two ear portions; when the operation rod is rotatable to be near the sleeving portion so that the body portion drives at least one of the main body and the two ear portions; a first side portion of the sleeving portion and the driving portion are located at the same side of the operation rod, and in the first direction, the first side portion is protrusive beyond the connecting arm and relatively higher than the driving portion; the sleeving portion further includes a second side portion, the second side portion is located at a side opposite to the first side portion, the second side portion and the threaded portion are located at the same side of the operation rod, the second side portion and the connecting arm are aligned with each other, and the end face of the threaded portion is non-protrusive beyond the connecting arm; the first assembling portion is a hexagonal recess, the second assembling portion is a linear recess; a diametric dimension of the driving portion is larger than a diametric dimension of the threaded portion; the body portion is cylindrical; the driving portion is partially engaged within the through hole; the sleeving hole is polygonal.

9. The socket wrench of claim 1, wherein the connecting arm further includes a main body, the main body is connected between the two ear portions and the sleeving portion, and in the axial direction of the pin member, the sleeving portion is protrusive beyond the main body for a distance larger than one quarter a thickness of the main body.

10. The socket wrench of claim 1, wherein the operation rod includes a head portion and a body portion connected with each other, the head portion extends within the insertion space, the body portion is cylindrical and has an end surface which has a circular periphery, and the head portion is plate-shaped and connected to the end surface and located within the circular periphery of the end surface of the body portion.

11. The socket wrench of claim 10, wherein when the body portion is abutted against the two ear portions, the circular periphery of the end surface of the body portion is partially located within the insertion space.
